(19) United States
(12) Patent Application Publication
(10) Pub. No.: US 2013/0057954 A1
(43) Pub. Date: Mar. 7, 2013

(54) THREE-DIMENSIONAL IMAGE DISPLAY APPARATUS

(71) Applicants: Hironori NAKAHARA, Tokyo (JP); Nobuo Takeshita, Tokyo (JP)

(72) Inventors: Hironori NAKAHARA, Tokyo (JP); Nobuo Takeshita, Tokyo (JP)

(21) Appl. No.: 13/604,310

(22) Filed: Sep. 5, 2012

(30) Foreign Application Priority Data
Sep. 6, 2011 (JP) 2011-194314
Jul. 11, 2012 (JP) 2012-155421

(51) Int. Cl. G02B 27/22

(52) U.S. Cl. 359/463

(57) ABSTRACT

The three-dimensional image display apparatus includes a display unit having display pixels arranged in rows and columns, and configured to display right-eye images and left-eye images alternately at every other column. Lenticular lenses with positive refractive power are provided corresponding to respective columns of the display pixels. The lenticular lenses and the columns of the display pixels are the same in number. The lenticular lenses collimate light representing the right-eye images and light representing the left-eye images. A deflection optical element deflects the collimated light representing the right-eye images and the collimated light representing the left-eye images toward right-eye and left-eye three-dimensional viewing areas. The deflection optical element includes a plurality of planes extending in a direction of the columns of the display pixels and inclined relative to a normal line of the display unit. The planes and the columns of the display pixels are the same in number.

### BACKGROUND OF THE INVENTION

The present invention relates to a large-size three-dimensional image display apparatus that enables a user to view a three-dimensional image with naked eyes.

Conventionally, there is known a three-dimensional image display apparatus using an active shutter system. In the active shutter system, a display unit alternately displays a right-eye image and a left-eye image while switching between the right-eye image and the left-eye image at high speed (i.e., a field sequential system), and the displayed images are viewed using active shutter glasses. The active shutter glasses alternately shut right and left visual fields using liquid crystal shutters in synchronization with switching of the images so that the right-eye image is viewed by a right eye and the left-eye image is viewed by a left eye. However, the active shutter system has a disadvantage that it is troublesome for a user to wear the active shutter glasses.

In contrast, there is also known a three-dimensional image display apparatus using a lenticular lens system that enables a user to view a three-dimensional image with naked eyes (see, for example, Patent Document No. 1). In the lenticular lens system, lenticular lenses are provided in front of a display unit. The lenticular lenses are formed of a lot of arranged cylindrical lenses. The display unit alternately displays right-eye images and left-eye images as a pattern of stripes. The right-eye images and the left-eye images are separated horizontally using the lenticular lenses. The lenticular lenses are disposed so that the display unit is located at a focal plane of the lenticular lenses. An example of the three-dimensional image display apparatus using the lenticular lens system is disclosed in Japanese Laid-open Patent Publication No. H2-44995 (see FIGS. 1 and 3).

However, when the above described lenticular lens system is applied to a large-size display apparatus using, for example, LEDs (Light Emitting Diodes), there is a problem described below.

That is, in the large-size display apparatus, display pixels (LEDs) are large, and are arranged at large arrangement intervals. Therefore, radii of curvatures of the cylindrical lenses of the lenticular lenses become large, and a focal length of the lenticular lenses becomes longer. In order to locate the display unit at the focal plane of the lenticular lenses, the lenticular lenses need be disposed on a position distanced from the display unit. As a result, the lenticular lenses and the display unit cannot be disposed proximately to each other, and it becomes difficult to reduce a thickness of the display apparatus.

### SUMMARY OF THE INVENTION

The present invention is intended to solve the above described problems, and an object of the present invention is to provide a three-dimensional image display apparatus in which a display unit and lenticular lenses can be disposed proximately to each other.

According to an aspect of the present invention, there is provided a three-dimensional image display apparatus including a display unit having a plurality of display pixels arranged in rows and columns and configured to display right-eye images and left-eye images alternately at every other column. The three-dimensional image display apparatus further includes a plurality of lenticular lenses provided corresponding to respective columns of the display pixels of the display unit. The lenticular lenses have positive refractive power. The number of the lenticular lenses is the same as the number of the columns of the display pixels. The lenticular lenses collimate light representing the right-eye images and light representing the left-eye images with respect to the respective columns of the display pixels. The three-dimensional image display apparatus further includes a deflection optical element that deflects the light representing the right-eye images and the light representing the left-eye images collimated by the lenticular lenses with respect to the respective columns of the display pixels so that the light representing the right-eye images and the light representing the left-eye images respectively reach a right-eye three-dimensional viewing area and a left-eye three-dimensional viewing area. The deflection optical element includes a plurality of planes extending in a direction of the columns of the display pixels of the display unit and inclined relative to a normal line of the display unit, and the number of the planes is the same as the number of the columns of the display pixels.

With such a configuration, even when a size of the three-dimensional image display apparatus becomes large, the display unit and the lenticular lenses can be provided proximately to each other. Therefore, a thickness of the three-dimensional image dimensional display apparatus can be reduced.

### BRIEF DESCRIPTION OF THE DRAWINGS

In the attached drawings:

FIG. 1 is a view showing a basic configuration of a three-dimensional image display system including a large-size three-dimensional image display apparatus according to Embodiment 1 of the present invention;

FIG. 2 is a plan view showing an LED display unit and a front lens of the large-size three-dimensional image display apparatus according to Embodiment 1;

FIG. 3 is a plan view showing an optical system including an LED at a center portion of a screen of the display unit and the front lens of the large-size three-dimensional image display apparatus according to Embodiment 1;

FIG. 4 is a plan view showing an optical system including an LED at an end portion of the screen of the display unit and the front lens of the large-size three-dimensional image display apparatus according to Embodiment 1;

FIG. 5 is a plan view showing an optical system including a liquid crystal display unit and lenticular lenses of a three-dimensional image display apparatus according to a comparison example;

FIG. 6 is a plan view showing an optical system including an LED display unit and lenticular lenses of a three-dimensional image display apparatus according to the comparison example;

FIG. 7 is a plan view showing an LED display unit and a front lens of a large-size three-dimensional image display apparatus according to Embodiment 2 of the present invention;

FIG. 8 is a plan view showing an optical system including an LED at a center portion of a screen of the display unit and a front lens of the large-size three-dimensional image display apparatus according to Embodiment 2;

FIG. 9 is a plan view showing an optical system including an LED at an end portion of the screen of the display unit and the front lens of the large-size three-dimensional image display apparatus according to Embodiment 2; and

FIGS. 10A and 10B are respectively a plan view and a side view showing an LED display unit and a front lens of a large-size three-dimensional image display apparatus according to Embodiment 3 of the present invention.

### DETAILED DESCRIPTION OF THE PREFERRED EMBODIMENT

### Embodiment 1

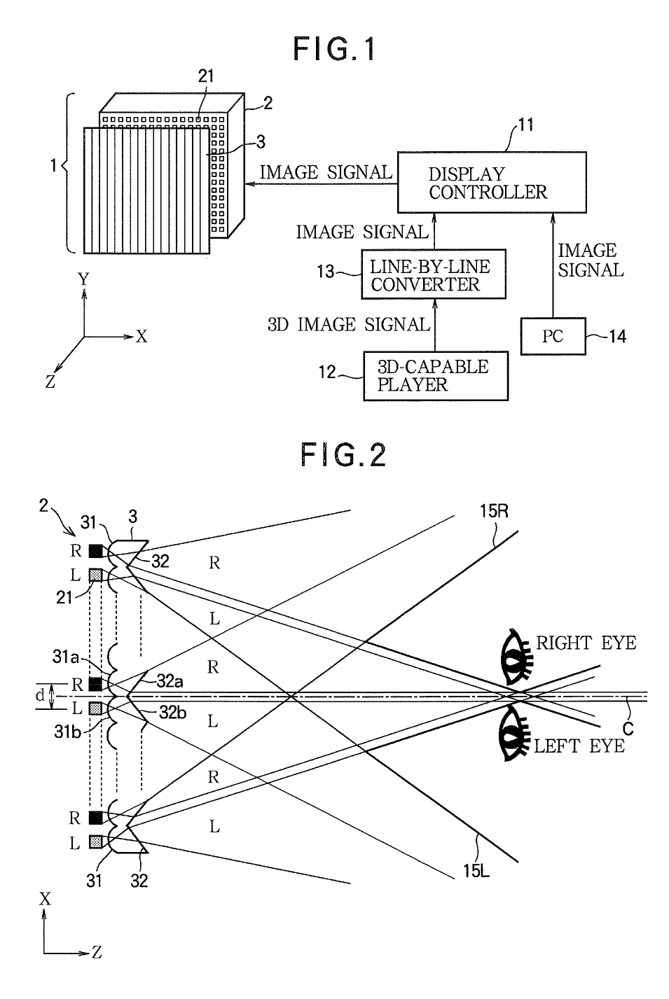

FIG. 1 is a view showing a basic configuration of a three-dimensional image display system including a large-size three-dimensional image display apparatus (i.e., a three-dimensional image display apparatus) 1 according to Embodiment 1 of the present invention. The large-size three-dimensional image display apparatus 1 includes LEDs (Light Emitting Diodes) as display pixels, and displays an image on a large screen with a size of, for example, 32V or more. The large-size three-dimensional image display apparatus 1 includes an LED display unit 2 as a display unit, and a front lens 3 provided in front of the LED display unit 2.

The LED display unit 2 is connected to a display controller (i.e., a display control unit) 11 having an image signal adjusting function and configured to output an image signal. The display controller 11 is connected to a line-by-line converter 13. The line-by-line converter 13 is connected to a 3D-capable player (i.e., a reproducing apparatus) 12 capable of outputting 3D image signal (i.e., three-dimensional image signal). The line-by-line converter 13 converts the 3D image signal outputted by the 3D-capable player 12 so that right-eye images and left-eye images are alternately displayed at every other column (i.e., a vertical line) as a pattern of stripes.

The display controller 11 is connected to a PC (i.e., a personal computer) 24. It is also possible to create a content in which right-eye images and left-eye images are alternately arranged at every other column using the PC 24, and to directly input the content from the PC 24 to the display controller 11.

In FIG. 1, a vertical direction (i.e., an up-down direction) of the LED display unit 2 is defined as a Y direction. A horizontal direction (i.e., a left-right direction) of the LED display unit 2 is defined as an X direction. A direction of a normal line of a screen of the LED display unit 2 (i.e., a direction perpendicular to both of the X direction and the Y direction) is defined as a Z direction.

FIG. 2 is a plan view showing the LED display unit 2 and the front lens 3. The LED display unit 2 includes LEDs 21 that constitute respective display pixels. Here, each LED 21 is configured as a three-color emission LED capable of emitting light of three colors: red, green and blue. An emission optical axis of each LED 12 is oriented in the Z direction.

The LEDs 21 are arranged at equal pitches (i.e., arrangement intervals) d in the X direction (i.e., in a row direction) and in the Y direction (i.e., in a column direction). The LEDs 21 are controlled by the display controller 11, and display the right-eye images (R) and the left-eye images (L) alternately at every other column.

The front lens 3 is formed of a transparent resin (for example, an acrylic resin) or a glass. Lenticular lenses 31 are formed on a surface of the front lens 3 facing the LED display unit 2. The number of the lenticular lenses 31 is the same as the number of columns of the LEDs 21. The lenticular lenses 31 are constituted by cylindrical lenses (i.e., lens surfaces) arranged in the X direction. The cylindrical lenses have semicircular cross-sections (cut along a XZ plane) protruding toward the LEDs 21, and extend in the Y direction. Each cylindrical lens surface has a positive refractive power (i.e., lens effect) in the XZ plane. The lenticular lenses 31 are disposed so that the display pixels (i.e., the LEDs 21) of the LED display unit 2 are located at a focal plane of the lenticular lenses 31.

The lenticular lenses 31 are provided corresponding to the respective columns of the LEDs 21 arranged in rows and columns of the LED display unit 2. Lens surfaces 31a of the lenticular lenses 31 face the columns of the LEDs 21 displaying the right-eye images (R), and receive light incident thereon from the LEDs 21 displaying the right-eye images (R). The lens surfaces 31a collimate the incident light, and emit parallel light. Lens surfaces 31b of the lenticular lenses 31 face the columns of the LEDs 21 displaying the left-eye images (L), and receive light incident thereon from the LEDs 21 displaying the left-eye images (L). The lens surfaces 31b collimate the incident light, and emit parallel light.

Prisms (i.e., deflection surfaces) 32 are provided on a side of the front lens 3 opposite to the lenticular lenses 31. Each of the prisms 32 is constituted by a pair of prism surfaces 32a and 32b (i.e., planes) both of which extend in the Y direction. The prism surfaces 32a and 32b are combined with each other to form a V-shape in an XZ plane (i.e., a horizontal plane).

The prisms 32 are arranged in the X direction. The prism surfaces 32a of the prisms 32 correspond to the columns of the LEDs 21 displaying the right-eye images (R). The prism surfaces 32b of the prisms 32 correspond to the columns of the LEDs 21 displaying the left-eye images (L).

The prism surfaces 32a deflect the parallel light emitted by the LEDs 21 (displaying the right-eye images) and passing through the lens surfaces 31a of the lenticular lenses 31 so that the parallel light reaches a three-dimensional viewing area (i.e., a three-dimensional viewing zone) 15R. The prism surfaces 32b deflect the parallel light emitted by the LEDs 21 (displaying the left-eye images) and passing through the lens surfaces 31b of the lenticular lenses 31 so that the parallel light reaches a three-dimensional viewing area (i.e., a three-dimensional viewing zone) 15L.

Image light (R, L) deflected by the prisms 32 (i.e., the prism surfaces 32a and 32b) reaches the three-dimensional viewing areas 15R, 15L as parallel light. When a right eye of a viewer is positioned in the three-dimensional viewing area 15R and a left eye of the viewer is positioned in the three-dimensional viewing area 15L, the viewer can view the right-eye images and the left-eye images, so that the viewer can recognize a three-dimensional image. In an example shown in FIG. 2, the viewer is located on a center line C of the large-size three-dimensional image display apparatus 1 so as to position the right eye and the left eye respectively in the three-dimensional viewing areas 15R and 15L.

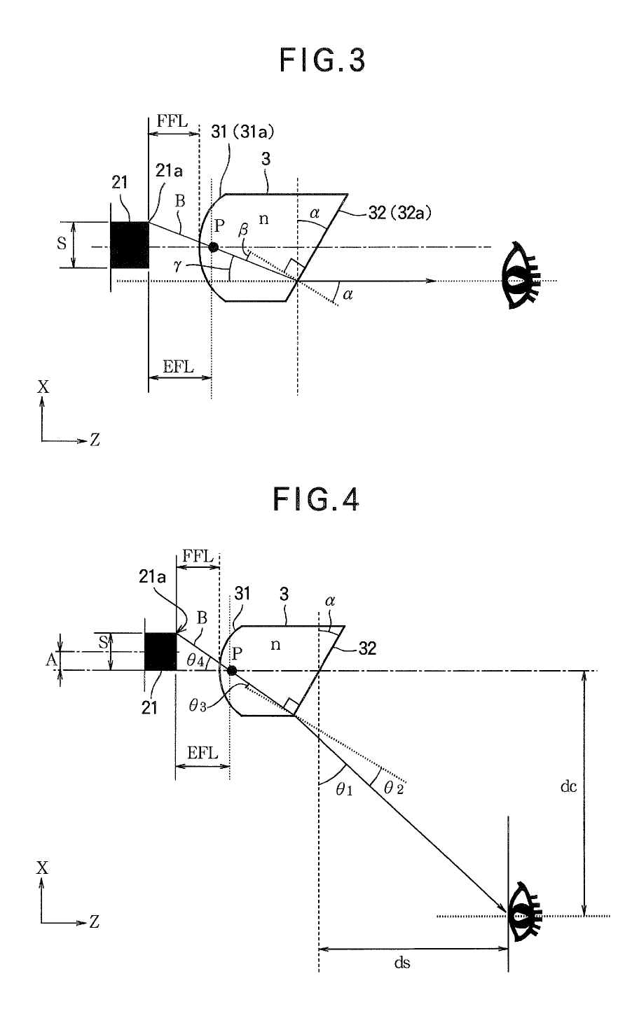

FIG. 3 is a plan view showing an optical system including the LED 21 at a center portion of the screen of the LED display unit 2 and the front lens 3. In FIG. 3, the LED 21 for displaying the right-eye image (R) is shown together with the lenticular lens 31 (i.e., the lens surface 31a) and the prism 32 (i.e., the prism surface 32a) facing the LED 21. At the center portion of the screen of the LED display unit 2, a center axis of the LED 21 is aligned with a center axis of the lenticular lens 31.

Here, a width (i.e., a dimension in the X direction) of the LED 21 is expressed as S. A distance from a focal point to a principal point P of the lenticular lens 31 is expressed as EFL.

A light ray B emitted from an end portion 21a of the LED 21 at the center of the screen (i.e., a position at a distance of S/2 from the center of the LED 21) passes through the principal point P of the lenticular lens 31, is subjected to a refraction action at the prism 32, and proceeds in the Z direction toward the viewer. In this regard, although only the light ray B passing through the principal point P is shown in FIG. 3, light (i.e., a flux of light rays) emitted by the end portion 21a of the LED 21 proceeds toward the viewer as parallel light having a center on the light ray B. An incident angle y at which the light ray B is incident on the lenticular lens 31 is determined by the following equation (1):

$$γ = arctan \frac{S}{2 \cdot EFL} \qquad ( 1 )$$

An inclination angle of the prism 32 (i.e., the prism surface 32a) relative to the Z direction is expressed as α. Using the inclination angle α, an incident angle β at which the light ray B is incident on the prism 32 after passing through the principal point P of the lenticular lens 31 is expressed by the following equation (2):

β=α−γ (2)

Here, when a refraction index of the front lens 3 is expressed as n, the following equation (3) is obtained from the law of refraction:

$$\frac{sin α}{sin β} = n \qquad ( 3 )$$

Using the equations (1) to (3), the inclination angle α of the prism 32 is determined based on the distance EFL from the focal point to the principal point P of the lenticular lens 31, the width S of the LED 21 and the refraction index n of the front lens 3.

For example, when the width S of the LED 21 is 2 mm, the distance EFL from the focal point to the principal point P of the lenticular lens 31 is 60 mm (i.e., a distance FFL from the LED 21 to the lenticular lens 31 is 59 mm), and the refraction index n of the front lens 31 is 1.61, the inclination angle a of the prism 32 is, for example, 2.5 degrees. Further, the incident angle β at which the light ray B is incident on the prism 32 is, for example, 1.55 degrees.

FIG. 4 is a plan view showing an optical system including the LED 21 at an end portion of the screen of the LED display unit 2 and the front lens 3. At the end portion of the screen of the LED display unit 2, the center axis of the LED 21 and the center axis of the lenticular lens 31 are shifted from each other in the X direction by a predetermined amount (i.e., a shift amount A).

The light ray B emitted by the end portion 21a of the LED 21 passes through the principal point P of the lenticular lens 31, is subjected to the refraction action at the prism 32, and proceeds in a direction at a predetermined angle (90−θ₁) relative to the Z direction. When a distance from the front lens 3 to the viewer in the Z direction is expressed as dₛ, and a distance from the center axis of the lenticular lens 31 to the viewer in the X direction is expressed as d_{c}, the above described angle θ₁ is expressed by the following equation (4):

$${θ}_{1} ≅ arctan \frac{{d}_{s}}{{d}_{c}} \qquad ( 4 )$$

Using the inclination angle a of the prism 32 and the above described angle θ₁, an emission angle θ₂ of the light ray B emitted from the prism 32 is expressed by the following equation (5):

θ₂=90−α−θ₁ (5)

Using the refraction index n of the front lens 3, a relationship between an incident angle θ₃ of the light ray B incident on the prism 32 and the emission angle θ₂ of the light ray B emitted from the prism 32 is expressed by the following equation (6):

$$\frac{sin {θ}_{2}}{sin {θ}_{3}} = n \qquad ( 6 )$$

Further, using the above described inclination angle α of the prism 32 and the incident angle θ₃ of the light ray B incident on the prism 32, an incident angle θ₄ of the light ray B incident on the lenticular lens 31 is expressed by the following equation (7):

θ₄=α+θ₃ (7)

Using the incident angle θ₄ determined by the equation (7) and the distance EFL from the focal point to the principal point P of the lenticular lens 31, the shift amount A between the center axis of the LED 21 at the end portion of the screen and the center axis of the lenticular lens 31 is determined by the following equation (8):

$$A = EFL \cdot tan {θ}_{4} - \frac{S}{2} \qquad ( 8 )$$

That is, at the end portion of the screen, the lenticular lens 31 is disposed so that the shift amount A determined by the equation (8) exists between the center axis of the lenticular lens 31 and the center axis of the LED 21.

For example, when the distance dₛ from the front lens 3 to the viewer in the Z direction is 1500 mm, and the distance d_{c} from the center axis of the lenticular lens 31 to the viewer in the X direction is 300 mm, the shift amount A between the center axis of the lenticular lens 31 and the center axis of the LED 21 is 7.4 mm.

With such a configuration, light representing the right-eye images (R) emitted by the LEDs 21 of the LED display unit 2 is collimated by the lenticular lenses 31, and the resulting parallel light is deflected by the prisms 32 to reach the three-dimensional viewing area 15R. Light representing the left-eye images (L) emitted by the LEDs 21 of the LED display unit 2 is collimated by the lenticular lenses 31, and the resulting parallel light is deflected by the prisms 32 to reach the three-dimensional viewing area 15L. The viewer can view three-dimensional image by positioning the right eye and the left eye respectively in the three-dimensional viewing areas 15R and 15L.

As described above, according to Embodiment 1 of the present invention, the lenticular lenses 31 are provided corresponding to the respective columns of the LEDs 21 of the LED display unit 2. The lenticular lenses 31 collimate the image light, and the prisms 32 deflect the collimated parallel light. Therefore, even when the three-dimensional image display apparatus 1 is large, the lenticular lenses 31 can be disposed proximately to the LEDs 21. Accordingly, a thickness of the three-dimensional image display apparatus 1 can be reduced.

Further, each of the cylindrical lenses of the lenticular lenses 31 is only required to have a width corresponding to a width of one column of the LEDs 21. Therefore, a radius of each of the cylindrical lenses of the lenticular lenses 31 can be reduced. As a result, manufacturing of the lenticular lenses 31 can be facilitated.

### COMPARISON EXAMPLE

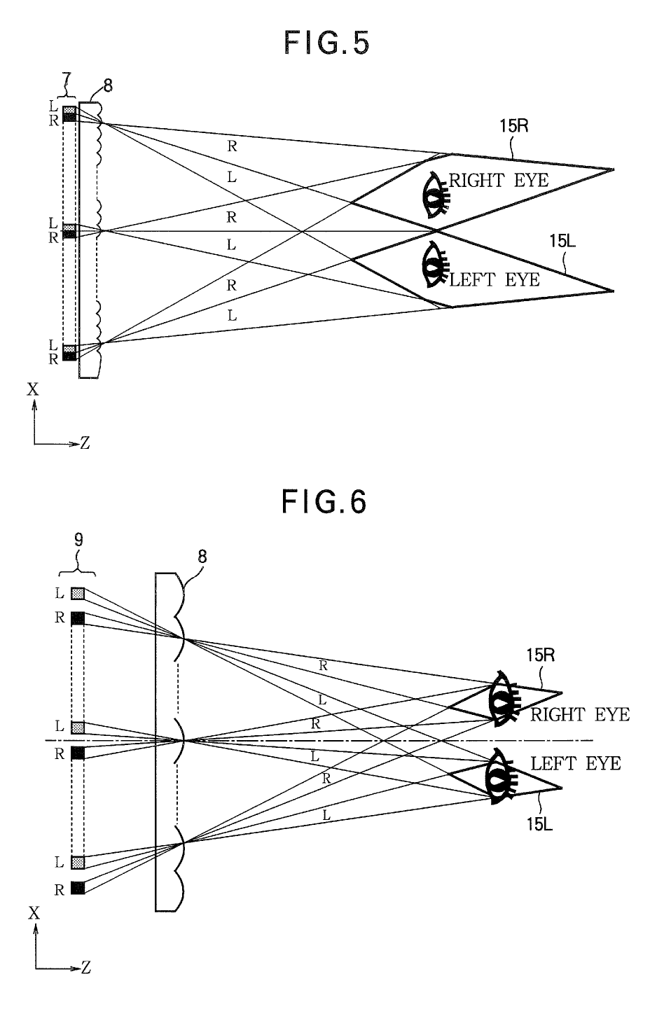

A comparison example to be compared with to Embodiment 1 will be herein described. FIG. 5 is a plan view showing an optical system of a three-dimensional image display apparatus according to the comparison example. The three-dimensional image display apparatus shown in FIG. 5 includes a liquid crystal display unit 7, and lenticular lenses 8 disposed in front of the liquid crystal display unit 7. The lenticular lenses 8 are disposed in such an orientation that cylindrical lenses thereof face away from the liquid crystal display unit 7.

The liquid crystal display unit 7 includes a display surface located on a focal plane of the cylindrical lenses 8, and alternately displays the right-eye images (R) and the left-eye images (L) as a pattern of stripes. Each of the cylindrical lenses of the lenticular lenses 8 receives image light (R, L) emitted by two columns of pixels of the liquid crystal display unit 7, and directs the image light toward the three-dimensional viewing area 15R for the right eye and the three-dimensional viewing area 15L for the left eye.

FIG. 6 shows an example in which the three-dimensional image display apparatus of FIG. 5 is embodied in a large-size three-dimensional image display apparatus with LEDs. The large-size three-dimensional image display apparatus shown in FIG. 6 has an LED display unit 9 instead of the liquid crystal display unit 7 (FIG. 5).

In the large-size three-dimensional image display apparatus shown in FIG. 6, LEDs as the display pixels of the LED display unit 9 are large, and arranged at large arrangement intervals. Therefore, it is necessary to increase a radius of curvature of each of the cylindrical lenses of the lenticular lenses 8, which results in an increase in a focal length. As a result, the lenticular lenses 8 need be disposed apart from the LED display unit 9. That is, it becomes difficult to dispose the lenticular lenses 8 and the LED display unit 9 proximately to each other.

In contrast, according to the above described Embodiment 1 (FIGS. 1 through 4), the lenticular lenses 31 are provided corresponding to the respective columns of the LEDs 21 of the LED display unit 2. The lenticular lenses 31 collimate the image light (R, L), and the prisms 32 deflect the collimated parallel light and direct the collimated parallel light toward the three-dimensional viewing areas 15R and 15L. Therefore, even when the lenticular lenses 31 are disposed proximately to the LEDs 21, the image light (R, L) from the LEDs 21 can reach the three-dimensional viewing areas 15R and 15L so as to form a three-dimensional image. Moreover, since the lenticular lenses 31 are disposed proximately to the LEDs 21, diffusion of light in a space between the LEDs 21 and the lenticular lenses 31 can be minimized. As a result, it becomes possible to display an image with high contrast.

Further, since it is not necessary to increase the size of the lenticular lenses 31 as shown in FIG. 6, manufacturing of the lenticular lenses 31 can be facilitated and manufacturing cost can be reduced.

### Embodiment 2

Next, a large-size three-dimensional image display apparatus according to Embodiment 2 of the present invention will be described. Overall configurations of a large-size three-dimensional image display apparatus and a three-dimensional image display system of Embodiment 2 are the same as those of Embodiment 1.

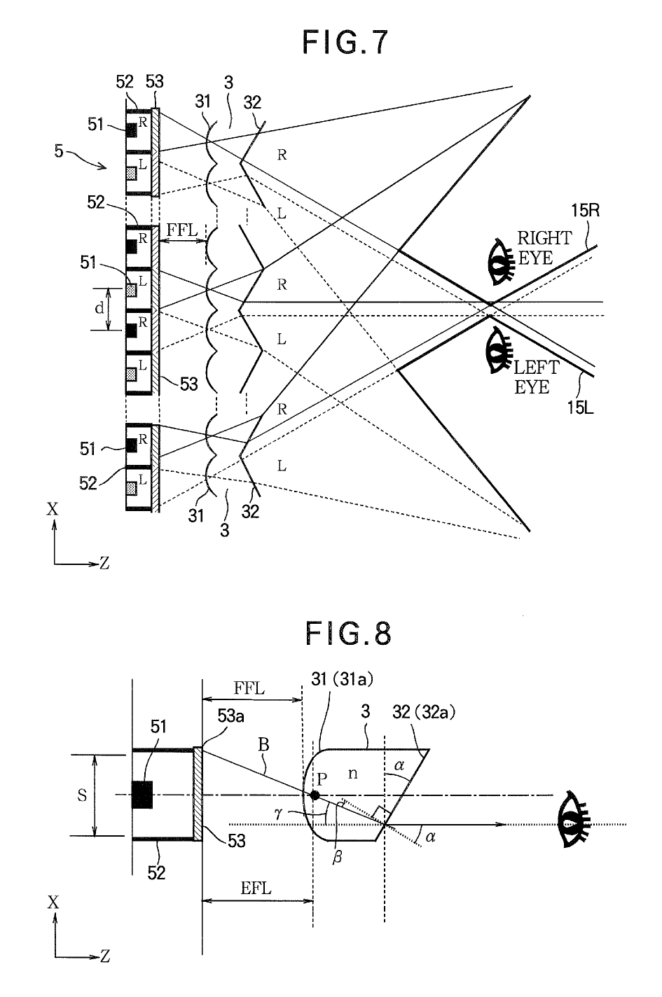

FIG. 7 is a plan view showing an optical system including an LED display unit 5 and a front lens 3 of the large-size three-dimensional image display apparatus according to Embodiment 2. The LED display unit 5 includes LEDs 51 as display pixels. The LEDs 51 are arranged at equal pitches d in the X direction and in the Y direction. Each LED 51 is configured in a substantially similar manner to the LED 21 of Embodiment 1, but are smaller than the LED 21.

In Embodiment 2, the LEDs 51 are separated from each other by partition walls 52. The partition walls 52 are formed in the X direction and in the Y direction in a grid-like pattern. The partition walls 52 have reflection surfaces (i.e., mirror surfaces) that reflect light from the LEDs 51.

A diffusion sheet 53 (i.e., a diffusion member) is fixed to the partition walls 52 so that the diffusion sheet 53 faces the LEDs 51. The diffusion sheet 53 diffuses the light from the LEDs 51, and emits the light. The diffusion sheet 53 is formed of, for example, a ground glass. The diffusion sheet 53 is not limited to a glass, but can be a resin.

The front lens 3 has the same configuration as that of Embodiment 1. In this regard, a surface of the diffusion sheet 53 is located on the focal plane of the lenticular lenses 31. In other words, the lenticular lenses 31 are disposed at a distance FFL from the diffusion sheet 53.

The lenticular lenses 31 collimate the light emitted by the LEDs 51 and diffused by the diffusion sheet 53 into parallel light. The collimated parallel light is deflected by the prism 32 so as to reach the three-dimensional viewing areas 15R and 15L. When the right eye and the left eye of the viewer are respectively positioned in the three-dimensional viewing areas 15R and 15L, the viewer can view the three-dimensional image. Other configurations of Embodiment 2 are the same as those described in Embodiment 1.

FIG. 8 is a plan view showing an optical system including the LED 51 at a center portion of a screen of the display unit 5 and the front lens 3. In FIG. 8, the LED 51 displaying the right-eye image (R) is shown together with the lenticular lens 31 (i.e., the lens surface 31a) and the prism 32 (i.e., the prism surface 32a) facing the LED 51.

Here, a width of the diffusion sheet 53 is expressed by S. A distance from the focal point (i.e., a surface of the diffusion sheet 53) to the principal point P of the lenticular lens 31 is expressed by EFL. The light ray B emitted by an end portion 53a of the diffusion sheet 53 at the center portion of the screen passes through the principal point P of the lenticular lens 31, is subjected to a refraction action at the prism 32, and proceeds in the Z direction toward the viewer. An incident angle y at which the light ray B is incident on the lenticular lens 31 is determined by the following equation (9):

$$γ = arctan \frac{S}{2 \cdot EFL} \qquad ( 9 )$$

When an inclination angle of the prism 32 is expressed as a, an incident angle β at which the light ray B is incident on the prism 32 after passing through the principal point P of the lenticular lens 31 is expressed by the following equation (10):

β=α−γ (10)

Here, when a refraction index of the front lens 3 is expressed as n, the following equation (11) is obtained from the law of refraction:

$$\frac{sin α}{sin β} = n \qquad ( 11 )$$

Using the equations (9) to (11), the inclination angle a of the prism 32 is determined based on the distance EFL from the focal point to the principal point P of the lenticular lens 31, the width S of the diffusion sheet 53, and the refraction index n of the front lens 3.

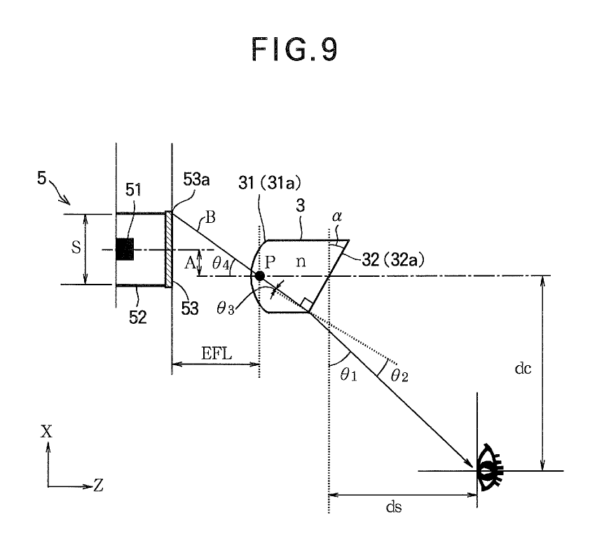

FIG. 9 is a plan view showing an optical system including the LED 51 at an end portion of the screen of the LED display unit 5 and the front lens 3. At the end portion of the screen of the LED display unit 5, the center axis of the LED 51 and the center axis of the lenticular lens 31 are shifted from each other in the X direction by a predetermined amount (i.e., a shift amount A).

The light ray B emitted by the end portion 53a of the diffusion sheet 53 passes through the principal point P of the lenticular lens 31, is subjected to the refraction action at the prism 32, and proceeds in a direction at an angle (90−θ0₁) relative to the Z direction. When a distance from the front lens 3 to the viewer in the Z direction is expressed as dₛ, and a distance from the center axis of the lenticular lens 31 to the viewer in the X direction is expressed as d_{c}, the above described angle θ₁ is expressed by the following equation (12):

$${θ}_{1} ≅ arctan \frac{{d}_{s}}{{d}_{c}} \qquad ( 12 )$$

Using the inclination angle a of the prism 32 and the above described angle θ₁, an emission angle θ₂ of the light ray B emitted from the prism 32 is expressed by the following equation (13):

θ₂=90−α−θ₁ (13)

Using the refraction index n of the front lens 3, a relationship between an incident angle θ₃ of the light ray B incident on the prism 32 and the emission angle θ₂ of the light ray B emitted from the prism 32 is expressed by the following equation (14):

$$\frac{sin {θ}_{2}}{sin {θ}_{3}} = n \qquad ( 14 )$$

Further, using the above described inclination angle α of the prism 32 and the incident angle θ₃ of the light ray B incident on the prism 32, an incident angle θ₄ of the light ray B incident on the lenticular lens 31 is expressed by the following equation (15):

θ₄=α+θ₃ (15)

Using the incident angle θ₄ determined by the equation (15) and the distance EFL from the focal point to the principal point P of the lenticular lens 31, the shift amount A between the center axis of the LED 51 at the end of the screen and the center axis of the lenticular lens 31 is determined by the following equation (16):

$$A = EFL \cdot tan {θ}_{4} - \frac{S}{2} \qquad ( 16 )$$

That is, at the end portion of the screen, the lenticular lens 31 is disposed so that the shift amount A determined by the equation (16) exists between the center axis of the lenticular lens 31 and the center axis of the LED 21.

With such a configuration, the light representing the right-eye images (R) and the left-eye images (L) emitted by the LEDs 51 of the LED display unit 5 is diffused by the diffusion sheet 53, and is collimated by the lenticular lenses 31. The resulting parallel light is deflected by the prisms 32 to reach the three-dimensional viewing areas 15R and 15L. The viewer can view a three-dimensional image by positioning the right eye and the left eye respectively in the three-dimensional viewing areas 15R and 15L.

As described above, according to Embodiment 2 of the present invention, the diffusion sheet 53 is provided on the light emission side of the LEDs 51, and therefore a large light emission area can be provided even when using relatively small LEDs 51. Therefore, in addition to the advantages described in Embodiment 1, Embodiment 2 provides an advantage that light use efficiency (i.e., an aperture ratio) can be enhanced.

In addition, the partition walls 52 surrounding the LEDs 51 have inner surfaces that reflect light from the LEDs 51, and therefore light use efficiency can be further enhanced.

In Embodiment 2, the partition walls 52 are provided so as to surround the respective LEDs 51, and the diffusion sheet 53 is provided in front of (i.e., on the light emission side of) the LEDs 51. However, it is also possible to provide only the partition walls 52, or to provide only the diffusion sheet 53.

### Embodiment 3

Next, a large-size three-dimensional image display apparatus according to Embodiment 3 of the present invention will be described. Overall configurations of a large-size three-dimensional image display apparatus and a three-dimensional image display system of Embodiment 3 are the same as those of Embodiment 1.

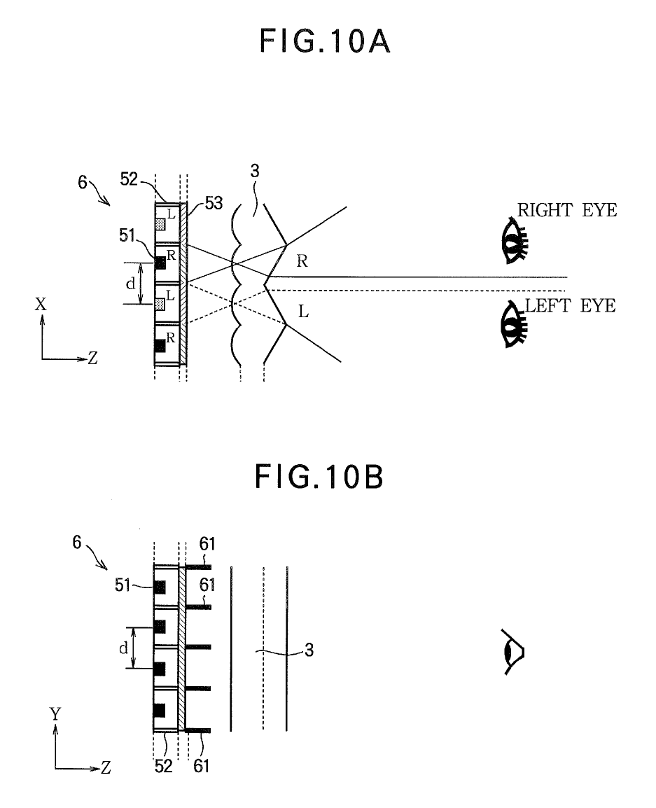

FIGS. 10A and 10B are respectively a plan view and a side view showing an optical system including an LED display unit 6 and a front lens 3 according to Embodiment 3. The LED display unit 6 of Embodiment 3 has substantially the same configuration as the LED display unit 5 (FIGS. 7-9) of Embodiment 2. However, in Embodiment 3, light shielding plates 61 (for example, sun visors) are provided on the light emission side (i.e., on the front lens 3 side) of the diffusion sheet 53, and are located on upper sides of the respective parts of the diffusion sheet 53 corresponding to the respective LEDs 51. The light shielding plates 61 are provided for preventing light (for example, external light such as sunlight) from being directly incident on the diffusion sheet 53 from above. Other configurations are the same as described in Embodiments 1 and 2.

According to Embodiment 3 of the present invention, the light shielding plates 61 are provided on the upper sides of the respective parts of the diffusion sheet 53 corresponding to the respective LEDs 51. Therefore, in addition to advantages described in Embodiments 1 and 2, Embodiment 3 provides an advantage that, even when the large-size three-dimensional image display apparatus is provided outdoors, reduction in contrast due to sunlight can be prevented.

In this regard, the light shielding plates 61 of Embodiment 3 can be applied to the LED display unit 2 of Embodiment 1. In this case, reduction in contrast due to sunlight can be prevented.

In the above described Embodiments 1 through 3, the LED display units 2, 5 and 6 are used as the display device for displaying an image. However, it is also possible to use other display unit such as a liquid crystal display unit, an organic Electro-Luminescence (EL) display unit and the like, as long as the display unit is able to display right-eye images and left-eye images alternately at every other column.

Further, in the above described Embodiments 1 through 3, the lenticular lenses 31 and the prisms 32 are provided on the front lens 3. The present invention is not limited to such a configuration. It is only necessary to collimate light representing right-eye images and left-eye images displayed on the display unit with respect to the respective columns of the display pixels using a plurality of lenses having a positive refractive power, and to deflect the collimated light with respect to the respective columns of the display pixels so that the collimated light reaches to the respective three-dimensional viewing areas.

The present invention is applicable to, for example, a three-dimensional image display apparatus (more preferably, a large-size three-dimensional image display apparatus using LEDs as display pixels) such as a three-dimensional television system.

While the preferred embodiments of the present invention have been illustrated in detail, it should be apparent that modifications and improvements may be made to the invention without departing from the spirit and scope of the invention as described in the following claims.

What is claimed is:

1. A three-dimensional image display apparatus comprising:
a display unit having a plurality of display pixels arranged in rows and columns, and configured to display right-eye images and left-eye images alternately at every other column;
a plurality of lenticular lenses provided corresponding to respective columns of the display pixels of the display unit, the lenticular lenses having positive refractive power, the number of the lenticular lenses is the same as the number of the columns of the display pixels, the lenticular lenses collimating light representing the right-eye images and light representing the left-eye images with respect to the respective columns of the display pixels, and
a deflection optical element that deflects the light representing the right-eye images and the light representing the left-eye images collimated by the lenticular lenses with respect to the respective columns of the display pixels so that the light representing the right-eye images and the light representing the left-eye images respectively reach a right-eye three-dimensional viewing area and a left-eye three-dimensional viewing area,
wherein the deflection optical element includes a plurality of planes extending in a direction of the columns of the display pixels of the display unit and inclined relative to a normal line of the display unit, and the number of the planes is the same as the number of the columns of the display pixels.

2. The three-dimensional image display apparatus according to claim 1, the deflection optical element is formed integrally with the lenticular lenses.

3. The three-dimensional image display apparatus according to claim 1, wherein a pair of the planes which are adjacent to each other are combined with each other in a V-shape as seen from above,
one of the pair of the planes deflects the light representing the right-eye image so that the light representing the right-eye image reaches the right-eye three-dimensional viewing area, and
the other of the pair of the planes deflects the light representing the left-eye image so that the light representing the left-eye image reaches the left-eye three-dimensional viewing area.

4. The three-dimensional image display apparatus according to claim 1, wherein a center axis of the display pixel at a center portion of a screen of the display unit is substantially aligned with a center axis of the lenticular lens, and
wherein a center axis of the display pixel at an end portion of the screen of the display unit is shifted from a center axis of the lenticular lens corresponding to the display pixel.

5. The three-dimensional image display apparatus according to claim 1, wherein the display unit includes a plurality of LEDs that constitute respective display pixels.

6. The three-dimensional image display apparatus according to claim 1, wherein the display unit includes partition walls that separate the display pixels from each other.

7. The three-dimensional image display apparatus according to claim 6, wherein the partition walls reflect light emitted by the display pixels.

8. The three-dimensional image display apparatus according to claim 1, further comprising a diffusion member that diffuses light emitted by the display pixels.

9. The three-dimensional image display apparatus according to claim 1, further comprising a light shielding member provided on an upper side of the display pixels, the light shielding member shielding external light.
